(19) United States
(12) Patent Application Publication
(10) Pub. No.: US 2013/0170323 A1
(43) Pub. Date: Jul. 4, 2013

(54) Method and System for Audio Detector Mode Activation

(71) Applicant: Richard Alan Smith, EI Dorado Hills, CA (US)

(72) Inventor: Richard Alan Smith, EI Dorado Hills, CA (US)

(21) Appl. No.: 13/342,387

(22) Filed: Jan. 3, 2012

(51) Int. Cl. G10K 11/00

(52) U.S. Cl. 367/197

(57) ABSTRACT

An acoustic detector comprises an acoustic sensor for receiving an acoustic signal. The acoustic signal selectively comprises a test sound with an encoded pattern indicative of the select mode. A controller is operatively associated with the acoustic sensor for analyzing the received acoustic signal to determine if the encoded pattern is present, changing a mode of operation if the encoded pattern is present, and selectively adjusting the operation of the acoustic detector based upon the received acoustic signal if mode is changed.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

This application relates to audio detectors and, more particularly, to a method and system for audio detector mode activation.

### BACKGROUND

An audio detector, such as an acoustic detector, is commonly used to detect and indicate attempts to break into premises. The most common acoustic detector is a glass breakage detector. The detector generates an alarm signal when the sound of a breaking window is detected. Typically, the detector is remotely mounted from the protected glass and is attached to a ceiling or a wall. The location of the detector is dependent on the size of the protected area and a number of other mounting restrictions that are manufacturer specific.

The glass breakage detector relies on detecting the sound of breaking glass by sensing one or more known frequency components associated with the sound of breaking glass. When the glass breakage detector is installed it is typically tested to ensure proper functionality. Additionally, it is tested to customize the detector for a given location, such that acoustic properties of the proximate environment are compensated for by a sensitivity adjustment to optimize the sensing range of the detector. Various common objects found in an indoor location can affect the performance of the detector, such as carpet, ceiling tiles, walls and/or floors, due to the reflection and absorption of frequency components.

To test glass breakage detector, a glass break simulator may be used to simulate the glass breakage. For example, U.S. Pat. No. 5,341,122 describes a glass breakage simulator capable of generating different frequency components indicative of broken glass. However, to adjust the level of sensitivity of the detector, an installer needs to open the detector each time the level must be changed. In practice, the sensitivity adjustment can occur several times, requiring the installer to manually adjust the sensitivity each time by changing a sensitivity setting device inside the detector. Since each installation is different, the installer may have to climb a ladder and open the detector multiple times before achieving the proper sensitivity level. This adjustment process is time consuming and cumbersome. Because the process is cumbersome, installers will often not optimize the range for the given site, leading to a less than ideal installation.

Accordingly, there is a need to be able to test the detector and adjust the sensitivity of the detector without requiring substantial effort by an installer.

U.S. Pat. No. 5,524,009 discloses an intrusion detector operating mode selection circuit that sets an operating mode responsive to an encoded acoustic signal. This system has the advantage of remote activation and a test signal being generated by a single device. However, operation of the device sometimes led to confusion resulting in some users abandoning the installation procedure. This results in installations of audio detection devices that are not properly verified or optimized.

### SUMMARY

Disclosed is a method for automatically adjusting the sensitivity level of an acoustic detector by transmitting a single acoustic signal to the acoustic detector. The acoustic signal comprises a test sound with an encoded pattern.

The method comprises receiving an acoustic signal from a remote device, the acoustic signal comprising a test sound with an encoded pattern indicative of the select mode; analyzing the received acoustic signal to determine if the encoded pattern is present; changing a mode of operation if the encoded pattern is present; and selectively adjusting the operation of the acoustic detector based upon the received acoustic signal if mode is changed.

The method includes storing a waveform signal in the remote device, the waveform signal representing the sound of breaking glass.

The method also comprises the acoustic signal including silent times selectively inserted in the test sound. The silent times may be spaced apart selective lengths of time corresponding to the encoded pattern. The silent times may be inserted at a beginning interval of the test sound. Duration of silent times may be uniform and time between silent times defining the encoded pattern.

The method also comprises the encoded pattern comprising one of a plurality of distinct codes representing distinct operating functions.

The method further comprises activating the remote device to transmit the acoustic signal by triggering the remote device. Triggering the remote device may comprise manually generating a low frequency sound and the remote device is triggered by the low frequency sound.

The method may also comprise the encoded pattern representing a test mode and selectively adjusting the operation of the acoustic detector comprises adjusting sensitivity of the acoustic detector based upon the received test sound in the test mode.

There is also disclosed an acoustic detector comprising an acoustic sensor for receiving an acoustic signal. The acoustic signal selectively comprises a test sound with an encoded pattern indicative of the select mode. A controller is operatively associated with the acoustic sensor for analyzing the received acoustic signal to determine if the encoded pattern is present, changing a mode of operation if the encoded pattern is present, and selectively adjusting the operation of the acoustic detector based upon the received acoustic signal if mode is changed.

Other features and advantages will be apparent from a review of the entire specification, including the appended claims and drawings.

### BRIEF DESCRIPTION OF THE DRAWINGS

FIG. 1 is a block diagram of a remote audio test device;

FIG. 2 is a flow diagram illustrating operation of the remote audio test device of FIG. 1;

FIG. 3 is a block diagram of an audio detector;

FIG. 4 is a flow diagram illustrating operation of the audio detector of FIG. 3; and

FIG. 5 is an illustration of a test waveform and a segment thereof illustrating insertion of an encoded pattern.

### DETAILED DESCRIPTION

The disclosed method and system for audio detector mode activation eliminates a separate test mode activation step. This is accomplished by using a specific test sound with an encoded pattern generated by an audio test device. An audio detector, such as a glass break detector, is designed to recognize the encoded pattern within the test sound, indicate that test mode is activated and uses the same received audio signal for the sensitivity optimization step. In one embodiment, the optimization step could be performed by the installer. In another embodiment, the optimization step could be performed by the detector itself, such as in Smith U.S. Pat. No. 7,830,750 and Smith et al. published application US2009/0040869, the specifications of which are incorporated by reference herein.

An audio encoding scheme is employed by introducing short “silent” times into the audio waveform. The silent times are detectable by an audio detector but are indiscernible to the human ear because the integration time of the ear and the brain. This approach results in the ability to embed the activation signal within the audio test waveform. One waveform can then be used to invoke the necessary mode of the desired device and supply the range test waveform.

The methodology disclosed herein is in connection with a glass break detector. However, with some variations, the steps are not limited to such an application and could be applied to other audio detectors which require various modes of operation.

In the case of a glass break detector, the installer will locate the remote test device near the window to be protected which is farthest from the audio detector and invoke the audio test signal. The installer will “trigger” the start of the audio test signal. In one embodiment, the audio test device can be triggered by a low frequency resulting from an intentional strike to the window with a soft cushion tool or soft side of the fisted hand. Such an audio test device is programmed to recognize the flexing of the glass using an internal microphone, as disclosed in Rickman U.S. Pat. No. 5,341,122, the specification of which is incorporated by reference herein. The installer will verify that the detector confirmed that it detected that the test signal was recognized. The installer is instructed to adjust the detector's sensitivity accordingly if it is not done automatically, as noted above. The detector provides confirmation of the step by indicating the results on its local indicator such as LEDs. Following the adjustment step, the installer may repeat the steps from the beginning for verification of a proper setup.

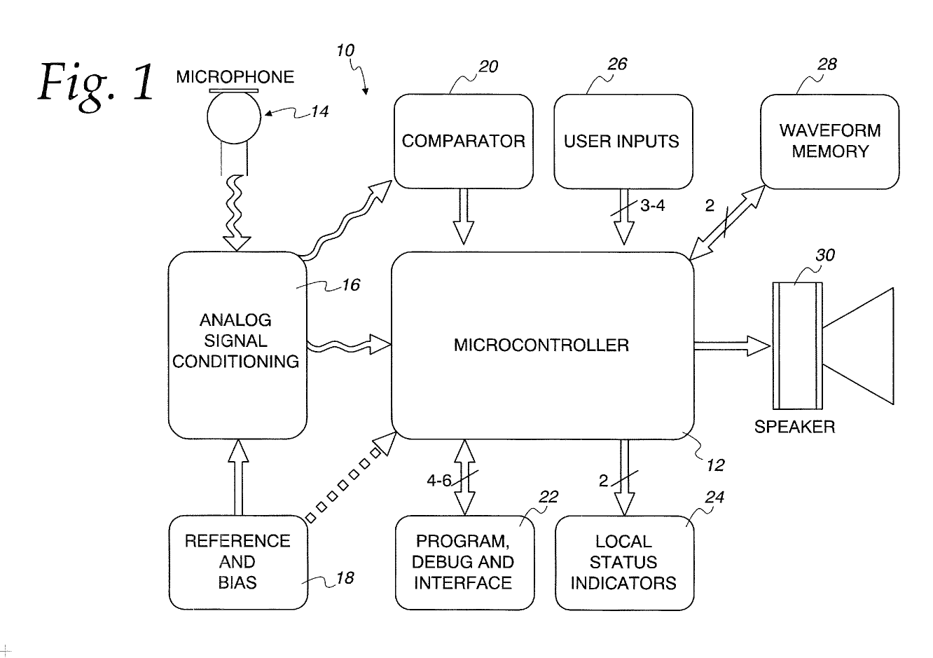

FIG. 1 illustrates a block diagram of an exemplary remote audio test device 10, also referred to herein as a test device or remote device. The test device 10 includes a conventional microcontroller 12 operating in accordance with a stored program for controlling operation. A microphone 14 is connected to the microcontroller 12 via an analog signal conditioning circuit 16. The microphone 14 is used for triggering the test device 10 as discussed above. The audio signal conditioning circuit 16 includes conventional buffer and filter circuits and provides a conditioned input to the microcontroller 12. A reference and bias circuit 18 is associated with the analog signal conditioning circuit 16. A comparator circuit 20 may also be connected between the analog signal conditioning circuit 16 and the microcontroller 12 to implement a wake up function. Alternatively, the comparator function could be internal to the microcontroller 12.

A program, debug and test interface circuit 22 is connected to the microcontroller 12 for production testing and setup. Local status indicators 24 are connected to the microcontroller 12 and may comprise LEDs or the like to indicate status. A user input circuit 26 is connected to the microcontroller 12 and may comprise toggle switches or the like for turning the test device 10 on or off or to directly trigger operation. The microcontroller 12 is also connected to a waveform memory 28. The waveform memory 28 stores a digitized test sound with an encoded pattern to indicate a select mode. Alternatively the waveform may be stored in the microcontroller 12. For example, the test sound may be a glass break signal with a code to activate the test mode. The microcontroller 12 is operatively connected to a speaker 30 for generating the acoustic signal based on the test sound stored in the waveform memory 28.

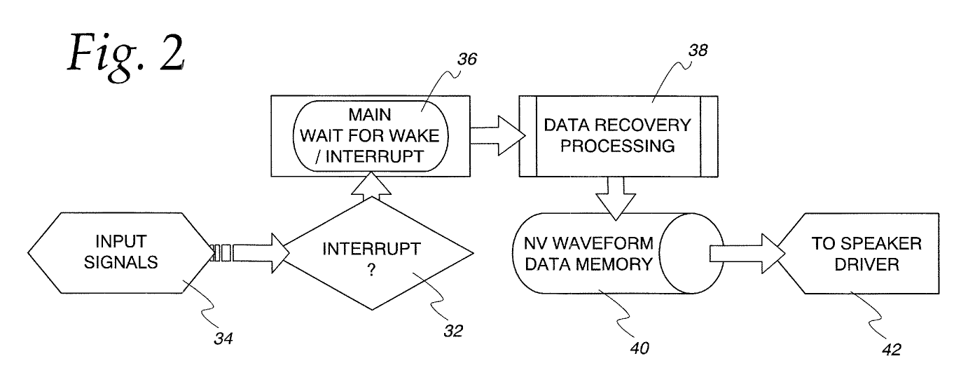

Referring to FIG. 2, a flow diagram illustrates operation of the program used by the microcontroller 12 of FIG. 1. An interrupt block 32 determines if any input signals are received from a block 34. The input signals could be from any one of the input blocks shown in FIG. 1. A main block 36 waits for an interrupt to wake up and begins a data recovery processing function at a block 38. Depending on the nature of the acoustic signal to be generated, the signal is retrieved from the waveform memory 28 at a block 40 and is provided to a speaker driver at a block 42.

For example, the interrupt could be caused by the user striking a glass pane, as noted above, which causes the transmission of an acoustic signal comprising a test sound with an encoded pattern indicative of the test mode.

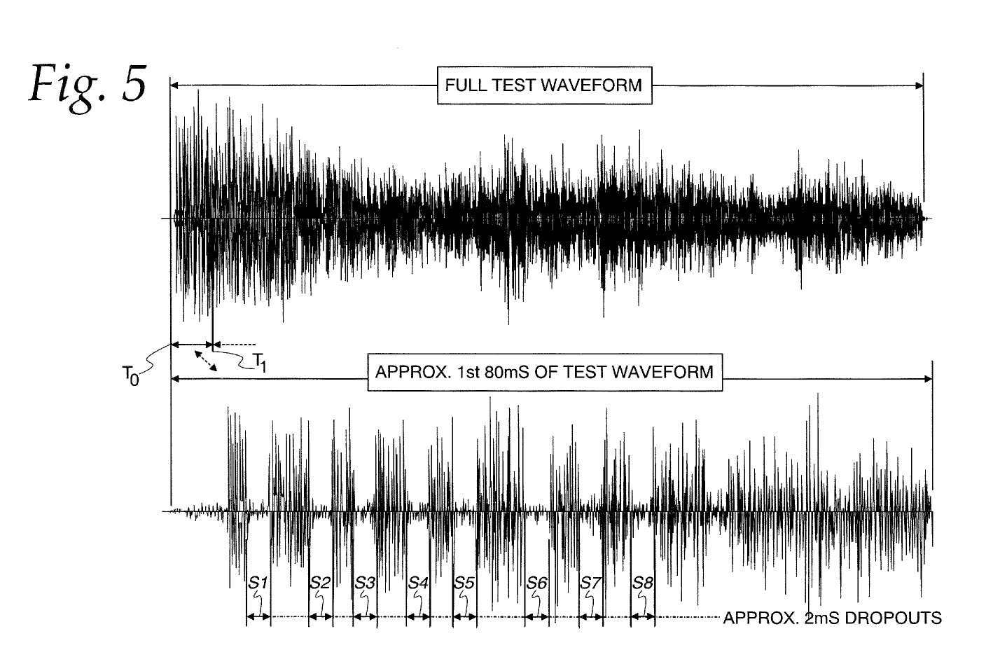

FIG. 5 illustrates at the top a full test waveform comprising a test sound simulating glass breakage. The beginning of the test sound is indicated as time T₀. The interval between time T₀ and time T₁ is an interval in which an encoded pattern is inserted in the waveform. This duration is shown expanded at the bottom of FIG. 5 wherein silent time intervals S1-S8 are inserted in the test sound. In the illustrated embodiment, the silent time intervals S1-S8 are spaced apart select lengths of time corresponding to the encoded pattern. Each silent time interval S1-S8 is of uniform duration with time between silent time intervals defining the encoded pattern. As will be appreciated, a plurality of different encoded patterns could be used comprising a plurality of distinct codes representing distinct operating functions.

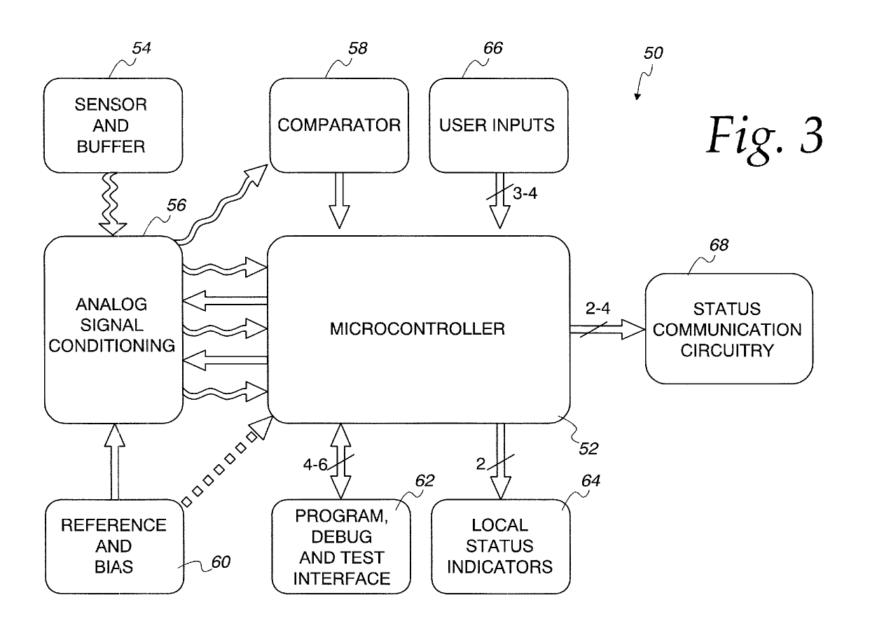

Referring to FIG. 3, a block diagram illustrates an exemplary embodiment of an audio detector 50 configured for automatic mode activation as described herein. The audio detector 50 includes a microcontroller 52 operating in accordance with a control program to process sound data as necessary for the particular application. In an exemplary embodiment, the audio detector 50 comprises a glass break detector.

The audio detector 50 includes a sensor and buffer circuit 54 for receiving acoustic signals. The sensor and buffer circuit 54 is connected via an analog signal conditioning circuit 56 to the microcontroller 52. A comparator 58 is connected between the analog signal conditioning circuit 56 and microcontroller 52 and is used for waking up operation of the microcontroller 52 in response to receiving an audio or acoustic signal. As above, the comparator function could be internal to the microcontroller 52. Similar to the test device 10, the audio detector 50 includes a reference and bias circuit 60, a program, debug and test interface circuit 62, local status indicators 64 and user inputs 66. A status communication circuit 66 is also connected to the microcontroller 52 and may be used to provide an alarm signal. The alarm signal could drive a local alarm device and/or be transmitted to a monitoring station, as necessary or desired.

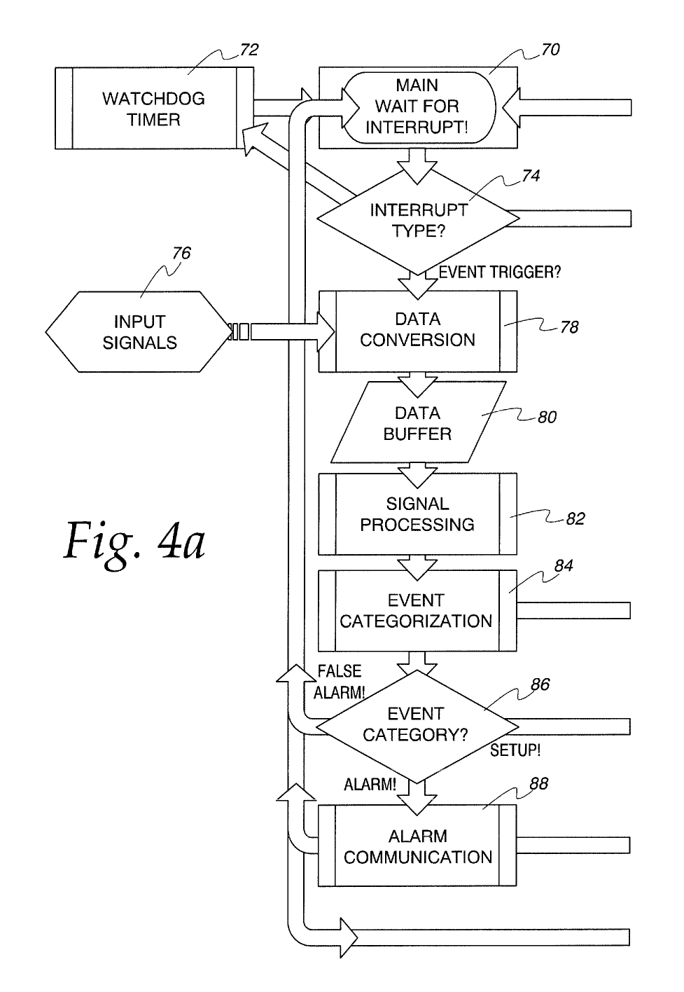

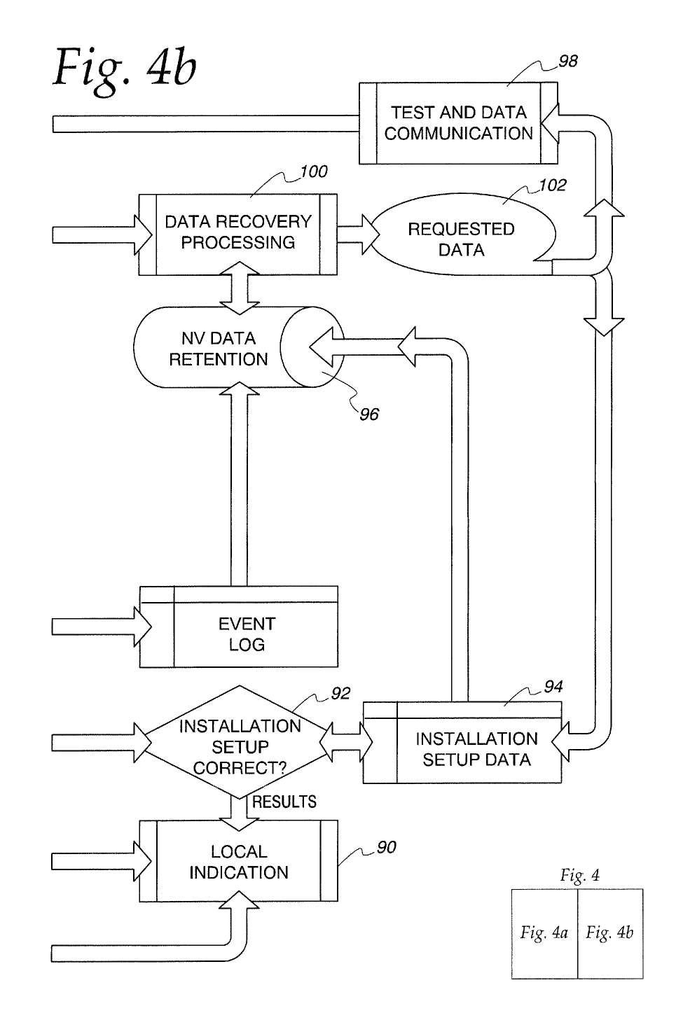

Referring to FIG. 4, a flow diagram illustrates operation of the program in the microcontroller 52 of FIG. 3. A main block 70 waits for an interrupt which could be from a watch dog timer 72 or from receiving a wake up signal, or the like. A decision block 74 determines the type of interrupt. If there is an event trigger, then an input signal at a block 76, such as an audio input from the sensor circuit 54, is sent to a data conversion block 78 for analog to digital conversion. The data is passed through a buffer 80 to a signal processing block 82. The signal processing block 82 determines if there is an encoded pattern, see FIG. 5, embedded within an acoustic signal. Particularly, the block 82 analyzes the acoustic signal for the presence of silent time intervals between time T₀ and time T₁ and determines if the pattern corresponds to a particular operating mode, such as a glass break test mode. A block 84 categorizes the event based on the analysis of the acoustic signal. The event could be categorized as an alarm, a false alarm, or a mode activation setup signal. A decision block 86 evaluates the event category. If a false alarm, then the program loops back to the main block 70. If an alarm event, then alarm communication is implemented at a block 88 such as by sending a signal to the status communication circuitry 66, see FIG. 3, resulting in local indication at a block 90, such as with the local status indicators 64, and then looping back to the main block 70.

If the acoustic sound includes an encoded pattern, then a decision block 90 determines if the installation set up is correct. For example, the signal processing block 82 would use the test sound to adjust operation of the acoustic detector such as by adjusting sensitivity based on level of the received test sound. The result of this would provide local indication at the block 90 and store installation set up data at a block 94. The set up data is stored in non-volatile memory at a block 96.

Additionally, test and data communication may be provided at a block 98 such as from a USB port, flash drive, or the like in which a data recovery processing block 100 may be used to request data at a block 102. This can also be used to update set up data at the block 94.

Thus, as disclosed herein, the audio detector 50 selectively receives an acoustic signal from a test device 10. The acoustic signal comprises a test sound with an encoded pattern indicative of a select mode. The select mode may be, for example, a test mode used for adjusting sensitivity and the like. Other modes according to the particular application could also be used. The audio detector 50 analyzes the received acoustic signal to determine if the encoded pattern is present. A mode of operation is changed if the encoded pattern is present. For example, the presence of the encoded pattern could be used to automatically switch to a test mode. If in the test mode, or other mode, the operation of the acoustic detector is adjusted based on the received acoustic signal. If the encoded pattern is not present, then no adjustment is implemented and the acoustic detector operates in a normal manner.

The present system and method have been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method of automatically activating a select mode of an acoustic detector comprising:
receiving an acoustic signal from a remote device, the acoustic signal comprising a test sound with an encoded pattern indicative of the select mode;
analyzing the received acoustic signal to determine if the encoded pattern is present;
changing a mode of operation if the encoded pattern is present; and
selectively adjusting the operation of the acoustic detector based upon the received acoustic signal if mode is changed.

2. A method of automatically activating a select mode of an acoustic detector of claim 1 further comprising storing a waveform signal in the remote device, the waveform signal representing sound of breaking glass.

3. A method of automatically activating a select mode of an acoustic detector of claim 1 wherein the acoustic signal includes silent times selectively inserted in the test sound.

4. A method of automatically activating a select mode of an acoustic detector of claim 3 wherein the silent times are spaced apart select lengths of time corresponding to the encoded pattern.

5. A method of automatically activating a select mode of an acoustic detector of claim 3 wherein the silent times are inserted at a beginning interval of the test sound.

6. A method of automatically activating a select mode of an acoustic detector of claim 3 wherein duration of silent times is uniform and time between silent times defines the encoded pattern.

7. A method of automatically activating a select mode of an acoustic detector of claim 1 wherein the encoded pattern comprises one of a plurality of distinct codes representing distinct operating functions.

8. A method of automatically activating a select mode of an acoustic detector of claim 1 further comprising activating the remote device to transmit the acoustic signal by triggering the remote device.

9. A method of automatically activating a select mode of an acoustic detector of claim 8 wherein triggering the remote device comprises manually generating a low frequency sound and the remote device triggers the low frequency sound.

10. A method of automatically activating a select mode of an acoustic detector of claim 1 wherein the encoded pattern represents a test mode and selectively adjusting the operation of the acoustic detector comprises adjusting sensitivity of the acoustic detector based upon the received test sound in the test mode.

11. An acoustic detector comprising:
an acoustic sensor for receiving an acoustic signal, the acoustic signal selectively comprising a test sound with an encoded pattern indicative of the select mode;
a controller operatively associated with the acoustic sensor for analyzing the received acoustic signal to determine if the encoded pattern is present, changing a mode of operation if the encoded pattern is present, and selectively adjusting the operation of the acoustic detector based upon the received acoustic signal if mode is changed.

12. The acoustic detector of claim 11 wherein the test sound represents sound of breaking glass.

13. The acoustic detector of claim 11 wherein the acoustic signal includes silent times selectively inserted in the test sound.

14. The acoustic detector of claim 13 wherein the silent times are spaced apart select lengths of time corresponding to the encoded pattern.

15. The acoustic detector of claim 13 wherein the silent times are inserted at a beginning interval of the test sound.

16. The acoustic detector of claim 13 wherein duration of silent times is uniform and time between silent times defines the encoded pattern.

17. The acoustic detector of claim 11 wherein the encoded pattern comprises one of a plurality of distinct codes representing distinct operating functions.

18. The acoustic detector of claim 1 wherein the encoded pattern represents a test mode and the controller selectively adjusts sensitivity of the acoustic detector based upon the received test sound in the test mode.
